(19) United States
(12) Patent Application Publication
(10) Pub. No.: US 2026/0188561 A1
(43) Pub. Date: Jul. 2, 2026

(54) TRANSFORMER

(71) Applicant: SUNGROW POWER SUPPLY CO., LTD., Hefei, Anhui (CN)

(72) Inventors: Guoqing CAI, Hefei, Anhui (CN); Jiacai ZHUANG, Hefei, Anhui (CN); Hongxuan JI, Hefei, Anhui (CN)

(21) Appl. No.: 19/130,209

(22) PCT Filed: May 29, 2023
(86) PCT No.: PCT/CN2023/096739

§ 371 Date: May 15, 2025

(30) Foreign Application Priority Data
Dec. 30, 2022 (CN) 202211734313.0

(51) Int. Cl. H01F 27/28

(52) U.S. Cl. CPC H01F 27/2828

(57) ABSTRACT

A transformer includes an iron core, and an inner coil and an outer coil which are coaxially mounted on an iron core limb of the iron core. The inner coil is a pancake coil; and a wire leading means of the inner coil is leading out inner lead-out wires from an innermost winding of the inner coil towards a center side of the inner coil, and a wire leading means of the outer coil is radially leading out outer lead-out wires from an outermost winding of the outer coil towards the outer side of the outer coil. According to the transformer structure, both the inner lead-out wires and the outer lead-out wires can be located at positions where the magnetic field strength is weak, such that the eddy current loss of terminals of the inner lead-out wires and the outer lead-out wires can be greatly reduced.

### CROSS REFERENCE TO RELATED APPLICATIONS

This is the National Stage of Application No. PCT/CN2023/096739, filed on May 29, 2023, which claims priority to the Chinese Patent Application No. 202211734313.0, titled “TRANSFORMER”, filed on Dec. 30, 2022, the disclosure of which is also incorporated herein by reference.

### FIELD

The present application relates to the technical field of transformers, and in particular to a transformer.

### BACKGROUND

A transformer mainly consists of an iron core and coils. The iron core serves as a main magnetic circuit of the transformer and also acts as a framework for the coils. The coils, which serve as the electrical circuit part of the transformer, are made of copper or aluminum wires winding around the main magnetic circuit. The transformer includes inner and outer coils coaxially mounted outside an iron core column of the iron core, and insulation requirements must be met in the coils and between the inner coils and the outer coils.

For medium to high frequency, medium voltage, and high-capacity transformers, pancake coils are commonly used. The pancake coils are typically wound with flat wires, and coils turns into pancakes in a radial direction and then are arranged axially. The pancake coils offer good heat dissipation, high mechanical strength, convenient wire leading-out, and a wide range of applications. Currently, to reduce eddy current losses in the coils, multi-strand twisted enameled wires are often used to form transformer coils. However, at terminal lead-out points, the multi-strand characteristics may be lost due to processes such as stripping of insulation in a solder bath and crimping terminals. Moreover, the current method for leading out the inner coil is mostly done by leading out from the end of the inner coil to the outside. This method may further deteriorate the insulation between the inner and outer coils.

In summary, how to solve the problems of high eddy current losses and insulation deterioration in the coil leading-out of the transformer has become an urgent problem for those skilled in the art.

### SUMMARY

In view of this, a transformer is provided according to the present application to solve the problems of high eddy current losses and insulation deterioration in the coil leading-out of the transformer.

In order to implement the above objects, following technical solutions are provided according to the present application.

A transformer includes an iron core, an inner coil and an outer coil, and the inner coil and the outer coil are coaxially mounted outside an iron core column of the iron core. The inner coil is a pancake coil. A lead-out manner for the inner coil involves drawing an inner lead-out wire from the innermost layer of windings of the inner coil towards a center of the inner coil, while a lead-out manner for the outer coil involves radially drawing an outer lead-out wire from the outermost layer of windings of the outer coil towards an outer side of the outer coil.

### BRIEF DESCRIPTION OF THE DRAWINGS

For more clearly illustrating embodiments of the present application or technical solutions in the conventional technology, the drawings referred to for describing the embodiments or the conventional technology will be briefly described hereinafter. Apparently, the drawings in the following description are only some examples of the present application, and for those skilled in the art, other drawings may be obtained based on the provided drawing without any creative efforts.

FIG. 1 is a schematic axonometric view of an inner coil unit provided according to an embodiment the present application;

FIG. 2 is a schematic front view of the inner coil unit provided according to the embodiment of the present application;

FIG. 3 is a view in a direction of A1 in FIG. 2;

FIG. 4 is a view in a direction of A2 in FIG. 2;

FIG. 5 is a schematic front view of an outer coil unit provided according to an embodiment of the present application;

FIG. 6 is a view in a direction of B1 in FIG. 5;

FIG. 7 is a view in a direction of B2 in FIG. 5;

FIG. 8 is a schematic top view of a transformer provided according to an embodiment of the present application;

FIG. 9 is a schematic front view of the transformer provided according to the embodiment of the present application, in which two iron core columns are respectively mounted with a single inner coil unit and a single outer coil unit;

FIG. 10 is a schematic front view of the transformer provided according to the embodiment of the present application, in which two iron core columns are respectively mounted with three inner coil units and three outer coil units, and each is led out as an independent coil;

FIG. 11 is a schematic front view of the transformer provided according to the embodiment of the present application, in which first unit lead-out wires of the inner coil units on the iron core column are led out in series, and second unit lead-out wires of the outer coil units are led out in series;

FIG. 12 is a schematic front view of the transformer provided according to the embodiment of the present application, in which first unit lead-out wires of the inner coil units on the iron core column are led out in parallel, and second unit lead-out wires of the outer coil units are led out in parallel.

Reference numerals in the drawings are listed as follows:
1 iron core, 11 iron core column;
2 inner coil, 20 inner coil unit, 201 first unit lead-out wire, 21 inner lead-out wire;
3 outer coil, 30 outer coil unit, 301 second unit lead-out wire, 31 outer lead-out wire.

### DETAILED DESCRIPTION OF THE EMBODIMENTS

A core of the present application is to provide a transformer, to solve the problems of high eddy current losses and insulation deterioration in the coil leading-out of the transformer.

The technical solutions according to the embodiments of the present application will be described clearly and completely as follows in conjunction with the drawings in the embodiments of the present application. It is apparent that the described embodiments are only some of the embodiments according to the present application, rather than all the embodiments. All other embodiments obtained by those skilled in the art based on the embodiments of the present application without any creative work fall within the protection scope of the present application.

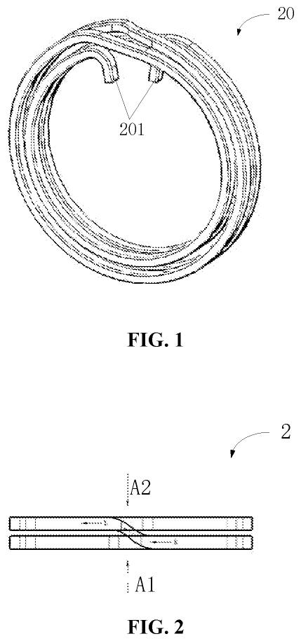

With reference to FIG. 1 to FIG. 12, a transformer is provided according to the present application, including an iron core 1, an inner coil 2 and an outer coil 3, and the inner coil 2 and the outer coil 3 are coaxially mounted outside an iron core column 11 of the iron core 1. A lead-out manner for the inner coil 2 involves drawing an inner lead-out wire 21 from the innermost layer of windings of the inner coil 2 towards a center of the inner coil 2. A lead-out manner for the outer coil 3 involves radially drawing an outer lead-out wire 31 from the outermost layer of windings of the outer coil 3 towards the outer side of the outer coil 3.

In the actual application process of the transformer, since the inner coil 2 is a crossover coil, the lead-out manner for the inner coil 2 may involve drawing the inner lead-out wire 21 from the innermost layer of windings of the inner coil 2 towards the center of the inner coil 2 in a way of positive and negative discs. That is to say, the inner lead-out wire 21 is located at inner side of the inner coil 2. At the same time, the lead-out manner for the outer coil 3 may involve radially drawing the outer lead-out wire 31 from the outermost layer of windings of the outer coil 3 towards the outer side of the outer coil 3. That is to say, the outer lead-out wire 31 is located at outer side of the outer coil 3. Based on the typical magnetic field distribution rule of the transformer, the magnetic field intensity between the primary coil and the secondary coil is the highest, and the electric field intensity between the inner side of the primary coil and the outer side of the secondary coil is close to zero. Moreover, since higher magnetic field intensity around the wires intensifies proximity effects and increases eddy current losses, positioning the inner lead-out wire 21 of the inner coil 2 at its innermost side and the outer lead-out wire 31 of the outer coil 3 at its outermost side ensures these lead-out wires reside in regions of weaker magnetic field intensity. As a result, the eddy current loss of the terminals of the inner lead-out wire 21 and the outer lead-out wire 31 can be significantly reduced. In addition, the structural form of the above-mentioned transformer enables the inner lead-out wire 21 to be shielded by the electric field of the inner coil 2, and the outer lead-out wire 31 to be shielded by the electric field of the outer coil 3, which effectively reduces the main insulation size between the inner coil 2 and the outer coil 3, and thus optimizes the insulation between the inner coil 2 and the outer coil 3.

It should be noted that the aforementioned inner coil 2 is generally a low-voltage coil, while the outer coil 3 is typically a high-voltage coil. Of course, it can be understood that when the transformer has special structural requirements, the inner coil 2 can also be a high-voltage coil, and the outer coil 3 can be a low-voltage coil. In practical applications, specific arrangement can be made based on actual needs, and no more specific limitations are imposed here.

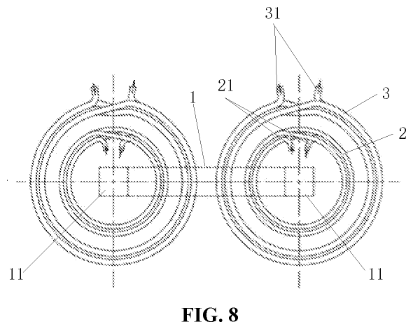

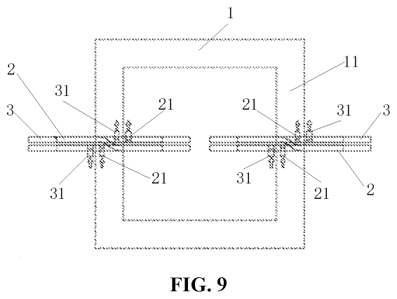

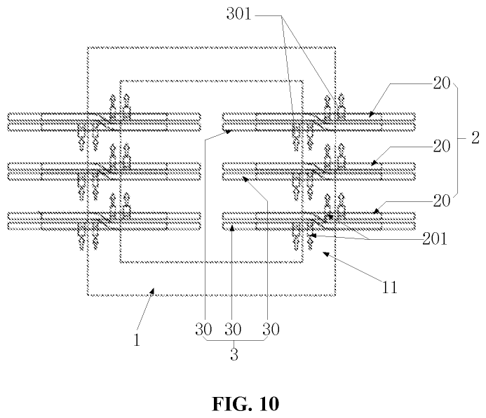

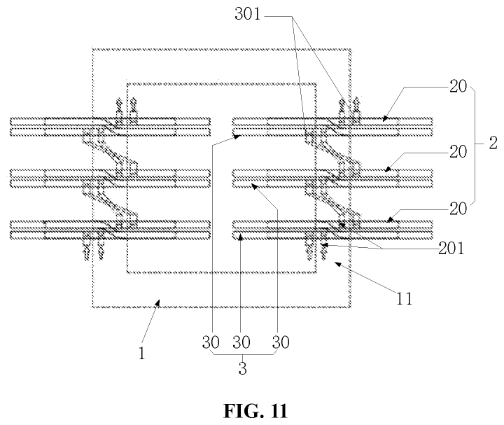

In some specific implementation, with reference to FIG. 1 to FIG. 4, the inner coil 2 may specifically include at least one inner coil unit 20. Even numbers of the pancake layers of the inner coil unit 20 are provided, with at least one turn per layer. The innermost winding of each inner coil unit 20 is led out towards the center of the inner coil unit 20 and forms a first unit lead-out wire 201. By designing the inner coil 2 in the aforementioned structural form, when applied to the transformer, the inner coil 2 may have a corresponding number of inner coil units 20 based on actual needs, with the specific number not being limited. For example, as shown in FIG. 8 and FIG. 9, one inner coil unit 20 is mounted outside the iron core column 11 of the iron core 1. Alternatively, as shown in FIG. 10 to FIG. 12, three inner coil units 20 are mounted outside the iron core column 11 of the iron core 1. Of course, the number of the inner coil units may be two or more than three.

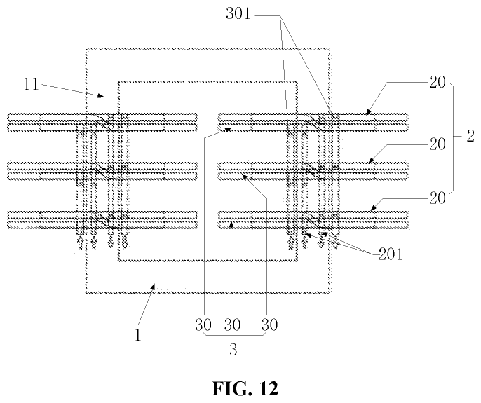

In further implementation, when the aforementioned inner coil 2 includes multiple inner coil units 20, first unit lead-out wires 201 of the inner coil units 20 can form the inner lead-out wire 21 respectively through series connection, parallel connection, or a combination of series and parallel connections. Specific arrangement can be made based on actual needs during practical application. For example, as shown in FIG. 11, the first unit lead-out wires 201 of the inner coil units 20 are connected in series to form the inner lead-out wire 21. The number of turns in the inner coil 2 can be increased by this series connection method. For the coils with a larger number of turns, a multi-layer with two sets of inner coil units 20 described above can be adopted, but this may result in an increase in coil thickness, leading to a decrease in power density. In such cases, it is preferable to use terminals to connect the first unit lead-out wires 201 of the multiple inner coil units 20 in series in low magnetic field areas, which reduces eddy current losses at the short-circuit connections. This forms a multi-layer pancake series structure, simplifies the process, and allows for reasonable splitting so as to achieve higher power density. Alternatively, as shown in FIG. 12, the first unit lead-out wires 201 of the inner coil units 20 are connected in parallel to form the inner lead-out wire 21, which can increase the number of strands in the inner coil 2. Of course, a combination of series and parallel connections can also be used, such as connecting the first unit lead-out wires 201 of the inner coil units 20 first in parallel and then in series, or first in series and then in parallel. It is also possible for some of the inner coil units 20 to have independent outputs, while others are connected in series or parallel.

In some other specific implementations, when the aforementioned inner coil 2 includes multiple inner coil units 20, each of the inner coil units 20 may also be designed to function as an independent coil, led out through a corresponding first unit lead-out wire 201. The method of independent output for the multiple inner coil units 20 allows for multi-channel independent use. For example, an application scenario could be a charging station drawing power from a high-voltage grid, where the high-voltage side coil (i.e., the outer coil) adopts an H-bridge cascade, and the low-voltage coils (i.e., the inner coil units 20) serve independently as multi-channel charging pile coils. This method is not illustrated with a specific drawing.

In some specific implementations, with reference to FIG. 9 to FIG. 11, the current inlet terminal and current outlet terminal of the first unit lead-out wire 201 of the aforementioned inner coil unit 20 may be designed to be arranged in a staggered manner vertically. This allows for insulation between the current inlet and outlet terminals of the inner coil unit 20.

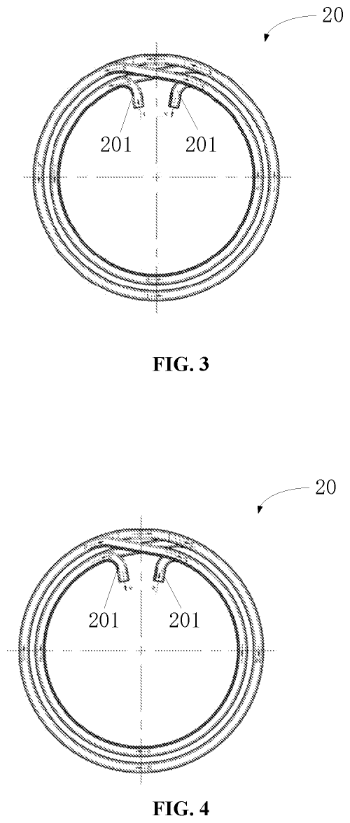

In some more specific implementations, the number of layers of windings for the aforementioned inner coil unit 20 is preferably two, with each layer having at least two turns. The inlet and outlet wires may be on the inner side of the coil, facilitating easy wire leading-out without the need to reserve an extra turn of space as in conventional solutions to achieve cross-layer inlet and outlet wires. Referring to FIG. 1 to FIG. 4, taking the example where each layer has two turns, due to the inlet and outlet terminals being on the inner side, the winding method viewing in a direction of Al in FIG. 2 is as follows: with reference to FIG. 3, the winding direction of the first layer is a (current inlet)→b→c→ . . . →k, wrapped outward in a counterclockwise direction; with reference to FIG. 2, wrapping in the direction k→L to the second layer; viewing in a direction of A2 in FIG. 2, the winding direction is L→m→n→ . . . →v (current outlet), wrapped inward in a clockwise direction. This structure can be specifically achieved through reverse-forward layer winding.

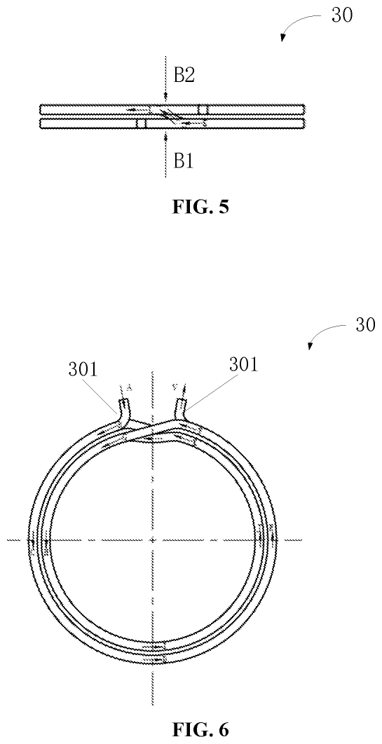

In some more specific implementations, referring to FIG. 5 to FIG. 7, the aforementioned outer coil 3 may preferably adopt a pancake-type coil design, specifically including at least one outer coil unit 30. Even numbers of the pancake layers in the outer coil unit 30 are provided, with each layer having at least one turn. The outermost winding of each outer coil unit 30 is led out radially outward from the outer side of the outer coil unit 30 to form a second unit lead-out wire 301. By designing the outer coil 3 in the aforementioned structural form, when applied to the transformer, the outer coil 3 can be configured with a corresponding number of the outer coil units 30 based on actual needs, with no specific limitation. For example, as shown in FIG. 8 and FIG. 9, one outer coil unit 30 is mounted outside the iron core column 11 of the iron core 1. Alternatively, as shown in FIG. 10 to FIG. 12, three outer coil units 30 are mounted outside the iron core column 11 of the iron core 1. Of course, the number of the outer coil units 30 may also be two or more than three.

In a further implementation, when the aforementioned outer coil 3 includes multiple outer coil units 30, the second unit lead-out wires 301 of the outer coil units 30 are connected in series, in parallel, or in a combination of series and parallel to form the outer lead-out wire 31. In practical application, specific arrangement can be made based on actual needs. For example, as shown in FIG. 11, the second unit lead-out wires 301 of the outer coil units 30 are connected in series to form the outer lead-out wire 31. This series connection allows for an increase in the number of turns of the outer coil 3. For the coils with a larger number of turns, a multi-layer with two sets of outer coil units 30 described above can be adopted, albeit potentially increasing the coil thickness and reducing power density. In such cases, it is preferable to use terminals to connect the second unit lead-out wires 301 of the multiple outer coil units 30 in series in low magnetic field areas, which reduces eddy current losses at the short-circuit connections. This forms a multi-layer pancake series structure, simplifying the process and enabling a more reasonable split for achieving higher power density. Alternatively, as shown in FIG. 12, the second unit lead-out wires 301 of the outer coil units 30 are connected in parallel to form the outer lead-out wire 31, which increases the number of strands in the outer coil 3. Of course, a combination of series and parallel connections can also be used, such as connecting the second unit lead-out wires 301 of the outer coil units 30 first in parallel and then in series, or vice versa. It is also possible to have some of the outer coil units 30 output independently while others are connected in series or parallel.

In some other specific implementations, when the aforementioned outer coil 3 includes multiple outer coil units 30, each of the outer coil units 30 can be designed to function as an independent coil, led out through a corresponding second unit lead-out wire 301. The method of independent output for the multiple outer coil units 30 allows for multi-channel independent use. For example, an application scenario could be a charging station drawing power from a high-voltage grid, where the high-voltage side coil (i.e., the outer coil) employs an H-bridge cascade, and the low-voltage coil (i.e., the inner coil unit 20) serves independently as a multi-channel charging pile coil. This method is not illustrated with a specific drawing.

It should be noted that in addition to the aforementioned combinations, there are also combination solutions where the inner coil is a pancake-type coil and the outer coil is a stack-type coil, which are also within the scope of protection of the present application. No corresponding drawing is provided for this combination solution.

In some specific implementations, referring to FIG. 9 to FIG. 11, the current inlet terminal and current outlet terminal of the second unit lead-out wire 301 of the aforementioned outer coil unit 30 can be designed to be arranged in a staggered manner vertically. This allows for insulation between the current inlet and current outlet terminals of the outer coil unit 30.

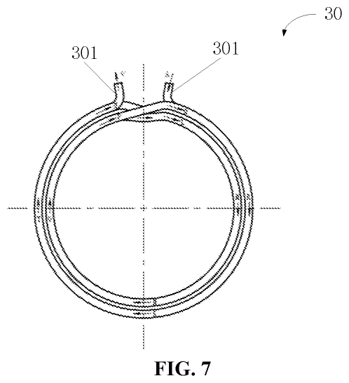

In some more specific implementations, the number of layers (or pancakes) of windings for the aforementioned outer coil unit 3 is preferably 2, with each layer having at least two turns. The inlet and outlet wires may be located on the inner side of the coil, facilitating easy wire leading-out and simple winding. Referring to FIG. 5 to FIG. 7, taking the example where each layer has two turns, there is no need to reserve extra space for an additional turn as in conventional designs to accommodate cross-layer inlet and outlet wires. Structurally, it remains largely consistent with conventional pancake coils. Considering the characteristics of multi-strand enameled wires, the present application preferably adopts a simple 2-layer multi-level pancake structure, which allows winding to proceed without the need for the “flipping” process traditionally used. The specific winding process is as follows: start by taking the midpoint of the wire and begin winding from the innermost layer; viewing in a direction of B1 in FIG. 5 and with reference to FIG. 6, the winding direction is against the current flow, that is, K→J→I→H→G→F→E→D→C→B→A; viewing in a direction of B2 in FIG. 5 and with reference to FIG. 7, the winding direction follows the current flow, that is, L→M→N→O→P→Q→R→S→T→U→V. Both layers are wound from the inside to the outside, facilitating the winding process. For the coils with more turns per layer, additional layers can be added, with the winding process remaining essentially the same.

In some other specific implementations, the aforementioned inner lead-out wires and outer lead-out wires can be designed in a staggered arrangement. This arrangement can enhance the insulation performance between the inner lead-out wires and the outer lead-out wires.

It should be noted that in practical applications, the number of the iron core columns 11 in the iron core 1 of the transformer is at least one, which may be one or multiple, and the specific number can be configured based on actual needs. Moreover, each iron core column 11 is coaxially provided with the aforementioned inner coil 2 and outer coil 3.

Additionally, it should be clarified that the preferred wire for winding the aforementioned inner coil 2 is multi-strand twisted enamel-coated wire. Similarly, the preferred wire for winding the aforementioned outer coil 3 is also multi-strand twisted enamel-coated wire. The use of multi-strand twisted enamel-coated wire for the pancake coil can reduce eddy current losses in high-frequency applications. The structure of the pancake coil can be determined based on the actual material of the wire and the pancake-turning process. With reference to FIG. 1 to FIG. 7, a 2-layer pancake structure is shown, which is simple to turn and exerts little force, avoiding damage to the multi-strand twisted enamel-coated wire. When the number of turns or strands in a single coil is large, it can be divided into multiple simple pancake coils for series-parallel connection. Of course, appropriate tooling can also be designed to reduce the difficulty of turning multi-turn coils.

In addition, it should be noted that the embodiments in this specification are described in a progressive manner, each of the embodiments emphasizes differences from other embodiments, and the same or similar parts among the embodiments can be referred to each other.

It should be understood that if “system”, “device”, “unit” and/or “module” are used herein, it is merely a method for distinguishing different assemblies, elements, components, portions or assembly at different levels. However, if other expressions can realize the same purpose, they may be replaced by other expressions.

As shown in the present application and claims, unless the context clearly indicates an exception, the words such as “one”, “a”, “an” and/or “the” do not specifically refer to the singular, but may also include the plural. Generally speaking, the terms “include” and “comprise” only indicate the inclusion of clearly identified steps and elements, and these steps and elements do not constitute an exclusive list, and a method or device may also include other steps or elements. The elements limited by the statement “comprising (including) a ... ” do not exclude the existence of other identical elements exist in the process, method, product or apparatus that includes the elements.

In the description of the embodiments of the present application, unless otherwise specified, “/” means or, for example, A/B can mean A or B. The “and/or” herein is only an association relationship that describes the associated objects, which means that there may be three kinds of relationships, for example, A and/or B may mean that there are three cases: A alone, A and B at the same time, and B alone. In addition, in the description of the embodiments of the present application, “multiple” refers to two or more.

Hereinafter, the terms “first” and “second” are only used for descriptive purposes, and cannot be understood as indicating or implying relative importance or implicitly indicating the number of indicated technical features. Therefore, a feature defined by “first” or “second” may explicitly or implicitly includes one or more of the features.

If a flowchart is used in the present application, the flowchart is used to explain the operation performed by the system according to the embodiment of the present application. It should be understood that the preceding or subsequent operations are not necessarily performed accurately in sequence. Instead, the steps can be processed in reverse order or simultaneously. In addition, other operations can be added to these procedures, or one or more operations can be removed from these procedures.

The principle and implementations of the present application are described herein by using specific examples, and the description of the above embodiments is only used to help understand the core idea of the present application. It should be noted that, several improvements and modifications may be made by those skilled in the art to the present application without departing from the principle of the present application, and these improvements and modifications also fall within the protection scope of the claims of the present application.

1. A transformer, comprising an iron core, an inner coil and an outer coil, wherein the inner coil and the outer coil are coaxially mounted outside an iron core column of the iron core, the inner coil is a pancake coil, and a lead-out manner for the inner coil involves drawing an inner lead-out wire from an innermost layer of windings of the inner coil towards a center of the inner coil, while a lead-out manner for the outer coil involves radially drawing an outer lead-out wire from an outermost layer of windings of the outer coil towards an outer side of the outer coil.

2. The transformer according to claim 1, wherein the inner coil comprises at least one inner coil unit, even numbers of pancake layers of the inner coil unit are provided, with at least one turn per layer, and an innermost winding of each inner coil unit is led out towards the center of the inner coil unit and form a first unit lead-out wire.

3. The transformer according to claim 2, wherein the inner coil comprises a plurality of inner coil units, and first unit lead-out wires of the plurality of inner coil units are connected in series, in parallel, or in a combination of series and parallel to form the inner lead-out wire.

4. The transformer according to claim 2, wherein the inner coil comprises a plurality of inner coil units, and each of the inner coil units serves as an independent coil led out through a corresponding first unit lead-out wire.

5. The transformer according to claim 2, wherein current inlet and outlet terminals of the first unit lead-out wire of the inner coil unit are arranged in a staggered manner vertically.

6. The transformer according to claim 2, wherein two layers of windings in the inner coil unit are provided, with each layer having at least two turns.

7. The transformer according to claim 1, wherein the outer coil is a pancake coil and comprises at least one outer coil unit, even numbers of pancake layers in the outer coil unit are provided, with each layer having at least one turn, and an outermost winding of each outer coil unit is led out radially outwards from the outer side of the outer coil unit to form a second unit lead-out wire.

8. The transformer according to claim 7, wherein the outer coil comprises a plurality of outer coil units, and the second unit lead-out wires of the plurality of outer coil units are connected in series, in parallel, or in a combination of series and parallel to form the outer lead-out wire.

9. The transformer according to claim 7, wherein the outer coil comprises a plurality of outer coil units, and each of the outer coil units serves as an independent coil led out through the second unit lead-out wire.

10. The transformer according to claim 7, wherein current inlet and outlet terminals of the second unit lead-out wire of the outer coil unit are arranged in a staggered manner vertically.

11. The transformer according to claim 7, wherein two pancake layers in the outer coil unit are provided, with each layer having at least two turns.

12. The transformer according to claim 1, wherein the inner lead-out wire and the outer lead-out wire are arranged in a staggered manner.

13. The transformer according to claim 1, wherein at least one iron core columns of the iron core is provided, and at least one iron core columns is coaxially provided with the inner coil and the outer coil.

14. The transformer according to claim 1, wherein the winding wire used for the inner coil is a stranded enamel-coated wire; and/or
the winding wire used for the outer coil is a stranded enamel-coated wire.

15. The transformer according to claim 1, wherein the inner coil is a low-voltage coil, and the outer coil is a high-voltage coil.
